(19) United States
(12) Patent Application Publication
(10) Pub. No.: US 2005/0196558 A1
(43) Pub. Date: Sep. 8, 2005

(54) Inkjet recording medium

(75) Inventors: Shinichi Suzuki, Tokyo (JP); Keiji Ohbayashi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA PHOTO IMAGING, INC.

(21) Appl. No.: 11/067,685

(22) Filed: Mar. 1, 2005

(30) Foreign Application Priority Data
Mar. 5, 2004 (JP) JP2004-061928

(51) Int. Cl. B41M 5/00

(52) U.S. Cl. 428/32.34

(57) ABSTRACT

An inkjet recording medium having: a support on which polyolefin resin is coated; and a porous ink absorbing layer containing a hydrophilic binder and inorganic fine particles, which is provided on the support, wherein a surface facing to the ink absorbing layer of the support is a fine-grained surface having about 5 through 10 rugged configurations arranged regularly at intervals of 3 mm; and wherein the surface has the center-line average roughness is not less than 2.5μm when a reference length is 2.5 mm and a cutoff value is 0.8 mm, and the ratio of the ten-point mean roughness of the surface to the center-line average roughness thereof is 4 to 7.

### TECHNICAL FIELD

The present invention relates to an inkjet recording medium of photo-grade quality, particularly to an inkjet recording medium of silky texture quality, characterized by a regular surface configuration and fine particles of comparative large projections and depressions.

### BACKGROUND

The inkjet recording medium can be broadly classified into two categories: One is the category of recording medium where the supporting member per se absorbs ink as in the case of paper; and the other is the category of recording medium where an ink absorbing layer is provided on the supporting member. In the case of the former category, ink is directly penetrates the supporting member, therefore, it has been impossible to obtain a high maximum density. Further, the supporting member per se absorbs the ink solvent, and causes wrinkles to be formed on the image. This has led to a failure in producing a print of quality appearance. Meanwhile, there are many types of commonly known recording media pertaining to the latter category where an ink absorbing layer is formed on the supporting member. When the supporting member absorbs an ink solvent, wrinkles still tend to occur. The dyestuff having dyed the ink absorbing layer gradually penetrates the supporting member during the storage period. This tends to reduce the density. Such problems have been left unsolved in the prior art.

To solve these problems, there is an inkjet recording medium with an ink absorbing layer provided on the non-absorbing supporting member that does not absorb ink at all. This inkjet recording medium involves no problem mentioned above, and provides an inkjet print characterized by quality appearance.

The known ink absorbing layer provided on the supporting member includes swelling type ink absorbing layer and a void type ink absorbing layer, when broadly classified.

The swelling type ink absorbing layer mainly contains a hydrophilic polymer such as gelatine, polyvinyl alcohol, polyvinyl pyrrolidone, or polyethylene oxide.

The void type ink absorbing layer can be classified into several categories according to the manufacturing method. A typical category includes a layer containing a small amount of hydrophilic polymer and a large amount of fine particles. Voids are formed among these fine particles, and ink is absorbed into these voids.

The swelling type ink absorbing layer is characterized by the capabilities of getting a high degree of glossiness, absorbing a large amount of ink within the polymer swelling range because of the use of a swelling polymer, and being produced at reduced costs. However, because of the use of swelling polymer, absorbing of the ink is very slow, and this type is gradually falling into disuse since it cannot meet the requirements of a recent high speed inkjet printer. When pigment ink is used for printing, there is a problem of poor fixing properties on pigment particles.

In the meantime, the void type ink absorbing layer is characterized by a high ink absorbing speed, absence of uneven printing in the phase of printing, apparently dried surface immediately after printing, and simultaneous satisfaction of the requirements for both moisture resistance and ink absorbing speed.

At present, both types are used according to the choice of a user. When consideration is given to higher absorbing speed and drying speed, however, the void type ink absorbing layer is more preferred in the sense of ensuring a better image surface.

Generally, in addition to the glossy surface, a matte surface and silky texture surface are known in the field of photographing. In the photo-grade quality inkjet, various surface qualities in addition to glossiness have been proposed. For example, the disclosed proposal covers an inkjet recording medium having a average roughness Ra of 0.8 through 4.0 and a 60-degree glossiness of 10 through 30% (e.g. the Official Gazette of Japanese Patent Tokkai 2000-355160); an inkjet recording medium wherein the supporting member surface is molded in such a way that the 75-degree mirror surface glossiness is below 30% (e.g. Official Gazette of Japanese Patent Tokkai 2001-63205); and an inkjet recording medium having such a surface characteristic that the Ra is 0.8 through 2.5 μm and the ten-point mean roughness Rz is 5 through 20 times the Ra (e.g. the Official Gazette of Japanese Patent Tokkai 2001-347748).

The present inventors have been engaged in the study of providing the inkjet recording medium with such a surface quality, particularly with silky texture quality, and have found out that a recording medium of subdued silky texture quality can be obtained if projections and depressions are comparatively deep and the fine particle surface is regular.

The present inventors have made further studies on this point and have found that, when a porous ink absorbing layer is arranged on polyolefin-coated paper, the surface tends to be rubbed in the phases of trimming the inkjet recording medium and subsequent physical distribution, and dotted streaks tend to be produced on the surface at the time of inkjet printing. It has been found out that this is because the print surface is rubbed for various reasons when the surface is engaged with the reverse side of the inkjet recording medium, due to greater sizes of projections and depressions on the surface. Alternatively, the projections are pressed when the print surface is rubbed by the nail or other comparatively hard substances, with the result that ink absorbing properties is affected thereby, according to their finding.

### SUMMARY

An aspect of the present invention provides an inkjet recording medium having:
a support on which polyolefin resin is coated; and
a porous ink absorbing layer containing a hydrophilic binder and inorganic fine particles, which is provided on the support,
wherein a surface facing to the ink absorbing layer of the support is a specific fine particle surface, and
wherein the surface has the specific center-line average roughness, and the specific ratio of the ten-point mean roughness of the surface to the center-line average roughness thereof.

### BRIEF DESCRIPTION OF THE DRAWINGS

FIG. 1 is a cross sectional view representing an example of a rugged configuration of the present invention.

### DETAILED DESCRIPTION OF THE PREFERRED EMBODIMENT

The following describes the further details of the characteristics. of the present invention:

(1) An inkjet recording medium having a porous ink absorbing layer comprising at least a hydrophilic binder and inorganic fine particles, the ink absorbing layer arranged on a paper supporting member covered with polyolefin resin on both sides, wherein the surface having a porous ink absorbing layer of the paper supporting member is a fine particle surface having about 5 through 10 rugged configurations arranged regularly at intervals of 3 mm; the center-line average roughness (Ra) is not less than 2.5 μm when the cutoff value specified in the JIS-B-0601 is 0.8 mm; and the ten-point mean roughness (Rz) is 4 through 7 times the center line average roughness (Ra).

(2) The inkjet recording medium described in (1), wherein the dry film thickness of the aforementioned porous ink absorbing layer is 30 through 50 μm.

(3) The inkjet recording medium described in (1) or (2), wherein the aforementioned porous ink absorbing layer contains at least one substance selected from:

urea,

an urea derivative,

a compound containing at least two hydroxyl groups in a molecule,

a compound containing at least two aliphatic ether groups in a molecule,

a latex emulsion with Tg not exceeding 10° C., and

an oil dispersion of a hydrophobic compound having a melting point not exceeding 40° C.

(4) The inkjet recording medium described in (3), wherein the content of at least one substance selected from the following is 0.5 through 10 percent by mass relative to the aforementioned inorganic fine particle:

urea,

an urea derivative,

a compound containing at least two hydroxyl groups in a molecule,

a compound containing at least two aliphatic ether groups in a molecule,

a latex emulsion with Tg not exceeding 10° C., and

an oil dispersion of a hydrophobic compound having a melting point not exceeding 40° C.

The aforementioned configuration of the present invention provides an inkjet recording medium of silky texture characterized by outstanding resistance against surface abrasion and cracks that may occur in the phases of trimming and subsequent physical distribution, even when a hard porous ink absorbing layer is applied on the paper supporting member covered with polyolefin resin characterized by comparatively deep projections/depressions and regular fine particle surface.

The following provides a detailed description of the present invention:

The inkjet recording medium of the present invention (hereinafter referred to as “recording medium” in some cases) uses a paper supporting member covered with polyolefin resin on both sides, and a porous ink absorbing layer is arranged on the paper supporting member (hereinafter referred to as “supporting member” in some cases).

The supporting member used for the recording medium of the present invention is covered with polyolefin resin on both sides.

The paper mainly contains wood pulp, and is manufactured, with synthetic pulp such as polypropylene or synthetic fiber such as nylon and polyester added to the wood pulp, as required. Any of LBKP, LBSP, NBKP, NBSP, LDP, NDP, LUKP and NUKP can be used as wood paper. Among these kinds of paper, LBKP, NBSP, LBSP, NDP and LDP containing a greater amount of short fiber are preferably contained in greater amounts. However, the ratio of the LBSP and/or LDP is preferred to be 10 to 70 percent by mass.

Chemical pulp containing less impurities (sulfate pulp or sulfite pulp) is preferably used as the aforementioned pulp. The pulp with the whiteness improved by bleaching is also useful.

As required, paper can be mixed with a sizing agent such as higher aliphatic acid and alkyl ketene dimer; a whitening agent such as calcium carbonate talc and titanium oxide; a paper strengthening agent such as starch, polyacryl amide and polyvinyl alcohol; and a softening agent such as dispersant and quaternary ammonium.

The freeness of the pulp used for paper making is preferably 200 through 500 ml according to the provision of CSF. The length of fiber after beating is preferably such that the sum of percent by mass of the residue on 24-mesh specified in the JIS-P-8207 and percent by mass of the 42-mesh calculated amount is 30 through 70 percent by mass. It is preferred that the percent by mass of the residue on 4-mesh should not exceed 20 percent by mass.

The basis weight of paper is preferably 50 through 250 g/m². Especially preferred basis weight is 70 through 220 g/m². The thickness of paper is preferably 50 through 220 μm.

Paper can be provided with a higher degree of smoothness by calendering process during or after paper making. The commonly used paper density is 0.7 through 1.2 g/cm³ (JIS-P-8118). Further, the stiffness of basis paper is preferably 20 through 300 g under the conditions. specified in the JIS-P-8143.

A surface sizing agent can be applied on the surface of paper. The surface sizing agent sizing agent having the same size as the one that can be added in the aforementioned basis paper.

The pH value of paper is preferably 5 through 9 when measured according to the hot water extraction method specified in the JIS-P-8113.

The following describes the polyolefin resin covering both sides of the paper supporting member:

It is preferred to use the polyolefin resin and its related substance such as copolymer and others mainly comprising polyethylene, polypropylene, polyisobutylene, ethylene and propylene. Of these, polyethylene is particularly preferred. Further, combined use of polyolefin resin with vinyl acetate and other thermoplastic resins is also allowed.

The following describes the particularly preferable polyethylene:

The polyethylene covering the obverse and reverse sides of paper is mostly low density polyethylene (LDPE) or high density polyethylene (HDPE). Other linear low density polyethylene (LLDPE) and polypropylene can also be used partly.

In particular, the polyolefin layer provided with a porous ink absorbing layer by coating is preferably the one with its opacity and whiteness improved by adding rutile and anatase type titanium oxide into the polyolefin. The amount of titanium oxide contained therein is normally 1 through 20 percent by mass relative to polyolefin, preferably 2 through 13 percent by mass.

A coloring pigment of high heat resistance or fluorescent whitening agent for adjusting the white background can be added into the polyolefin layer. The coloring agent includes ultramarine blue, Prussian blue, cobalt blue, phthalocyanine blue, manganese blue, cerulean blue, molybdenum blue, and anthraquinone blue. The fluorescent whitening agent includes diethylaminocoumarin, bisdimethylaminostilbene, bismethylaminostilbene, 4-alkoxy-1,8-naphthalene dicarboxylate -N-alkylimide, bispenzoxazolyl ethylene and dialkylstilbene.

The amount of the polyethylene used on the obverse and reverse sides of paper is selected so as to optimize the film thickness of the ink absorbing layer and the curl at a low or high humidity after the back layer has been arranged. Generally, 12 through 40 μm is adopted for the polyethylene layers on both sides where the ink absorbing layer is provided by coating, and 15 through 50 μm for the back layer side.

Further, the aforementioned paper supporting member coated with polyethylene is preferably provided with the following characteristics:

1. Tensile strength: preferably 2 through 30 kg in the longitudinal direction and 1 through 20 kg in the lateral direction, as specified in the JIS-P-8113.

2. Tear strength: preferably 10 through 200 g in the longitudinal direction and 20 through 200 g in the lateral direction, as specified in the JIS-P-8116.

3. Modulus in compression ≧98.1 MPa

4. Opacity: preferably 85% or more, particularly preferably 90 through 98% when measured according to the method specified in JIS-P-8138.

5. Whiteness: preferably L*=80 through 97, a*=−3 through +5 and b*=−10 through +5 according to the L*, a* and b* specified in JIS-Z-8729.

6. Clark degree of stiffness: The supporting member is preferred to have a Clark degree of stiffness in the direction of conveyance of recording medium is preferably 50 through 300 cm²/100.

7. Moisture content of basis paper: preferably 4 through 10 percent by mass relative to center stock.

The supporting member of the recording medium of the present invention is characterized in that fine particle-like projections and depressions of regular configuration are arranged on the obverse surface of the side provided with an ink absorbing layer. To give a subdued feeling to the print, the configuration of the projections and depressions of the present invention is preferably such that the difference of elevation is about 10 through 25 μm, and about 5 through 10 projections/depressions are located regularly in three millimeters.

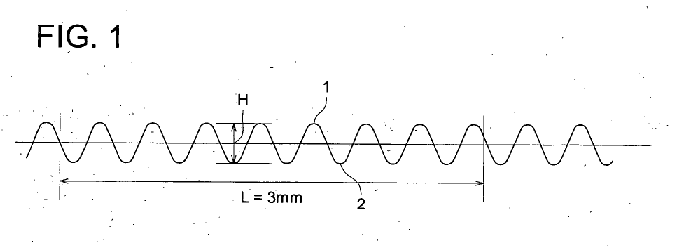

FIG. 1 is a cross sectional view showing an example of the configuration of projections/depressions of the present invention.

In the example of FIG. 1, eight projections/depressions are found in three millimeters. The difference of elevation between projection 1 and depression 2 is given by “H” (μm) in FIG. 1.

It is visually preferred that 5 to 10 projections/depressions should be regularly arranged. If the number is less than 5, granularity will be conspicuous. If the number is greater than 10, it will be difficult to identify individual projections and depressions visually. It will give an impression of being a matte surface.

Further, if the height of the projections and depressions is less than about 10 μm, the configuration will be less clear after porous ink absorbing layer of a comparatively thick coated film layer is coated, even if about 5 through 10 projections/depressions are regularly arranged in three millimeters. Such a surface tends to become a matted surface. Since the porous ink absorbing layer has a comparatively thick film layer, the projections/depressions on the surface of the supporting member tends to be reduced. Consequently, the height of the projections/depressions of the supporting member is preferably about 10 μm or more. This will provide a subdued feeling.

If the height of the projections/depressions exceeds 25 μm, on the other hand, the, there will be a sudden increase in the occurrence of cracks when the porous ink absorbing layer is coated, for example. This will cause an excessive amount of a coating solution to be put into the depressions, with a resultant decrease in the amount of coating solution for covering the projections. Thus, ink will overflow the projections to cause a reduction of image quality. If the projections are too high, troubles will occur more frequently at the time of printing, when the ink absorbing layer surface is rubbed. Such problems tend to occur.

The projections and depressions of the present invention are comparatively light and large, with a greater spacing between them. If the projections and depressions having a height and spacing arranged within a predetermined range are not used, cracks will occur when the ink absorbing layer is coated. To solve this difficulty, the aforementioned sufficient height and spacing are preferably provided.

The surface of the supporting member in the present invention is characterized in that, when the surface facing to the ink absorbing layer is measured according to the cutoff value of 0.8 mm, as specified in the JIS-B-0601, the center line average roughness (Ra) is 2.5 μm or more, and the ten-point mean roughness (Rz) is 4 through 7 times the center line average roughness (Ra).

The center-line average roughness (Ra) in the sense in which it is used in the present invention can be defined according to JIS-B-0601 as Ra that stipulates the surface roughness. To be more specific, the center line average roughness (Ra) is defined as the value obtained from the following equation expressed in micrometers (μm) when a measured length L is extracted from a roughness curve along the centerline; where X axis indicates the centerline of the extracted portion, Y axis shows the direction of longitudinal magnification and Y=f(X) denotes the roughness curve, and the cutoff value is 0.8 mm.

$$Ra = \frac{1}{L} {\int }_{0}^{L} \vert f ( x ) \vert ⅆ x$$

The ten-point mean roughness (Rz) can also be defined according to the JIS-B-0601 that stipulates the surface roughness. The ten-point mean roughness (Rz) is defined as follows: In the portion obtained by extracted the reference length from the sectional curve, a difference expressed in micrometers (μm) between:

the mean value of the elevations of the peaks from. the highest point to the 5th highest point, as measured in the direction of longitudinal magnification from the straight line, parallel to the mean line, without crossing the sectional curve; and

the mean value of the evaluation of the valleys from the lowest point to the fifth lowest point.

The center line average roughness (Ra) and ten-point mean roughness (Rz) are measured as follows: Samples are subjected to humidity control at a temperature of 25° C. with a relative humidity of 65 percent, without the samples under test being placed one on top of another. After that, the samples are measured. The condition of “without the samples under test being placed one on top of another” refers to the state where winding is performed with the film edge placed on a higher position, where fills are placed on top of another with paper sandwiched between them, or where a frame is formed of a card board and the like and its our corners are fixed in position, for example. The measuring instrument that can be used includes the Model RSTPLUS non-contact 3D microscopic surface profile measuring instrument by Wyko.

To provide a clear silky texture, it is necessary that the Ra on the surface of the supporting member should be 2.5 μm or more. If it is less than 2.5 μm, comparatively fine projections and depressions will be formed. This will make it difficult to get a silky texture having the large-sized projections and depressions intended in the present invention. The upper limit is approximately 4.0 μm to keep the Rz/Ra value within the range specified in the present invention. It is preferably 3.5 μm or less.

The Rz/Ra of the supporting member of the present invention partly overlaps the value of the supporting member where the Rz is 5 through 20 times the Ra as described in the Japanese Patent Tokkai 2001-347748, and is a comparatively lower value despite that. In the present invention, if the ratio of the Rz of the supporting member relative to the Ra is 7 or less, abrasion properties of the surface will be improved.

It is not clear why the Rz/Ra ratio defined in the present invention is so effective for the resistance of the surface against abrasion. The following reasons can be assumed:

The supporting member of the present invention configured in such a way that the Rz is not very large relative to Ra has projections characterized by a comparatively wide area. The uniform height of the projections can be easily adjusted. It can be assumed, consequently, that, even if any pressure is applied from outside, not much damage occurs because of the larger area for receiving the pressure. Further, the glossiness of the ink absorbing layer provided on such a supporting member is low, and a silky texture is provided. Accordingly, unevenness to a certain degree is absorbed by the projections and depressions, and hence is not conspicuous.

To satisfy the relationship between Rz and Ra, the tip end of the projection of the fine particle surface is usually comparatively flat and the height of the depression is made uniform wherever possible.

The lower limit of the radio of the Rz with respect to Ra is 4 or more, although it is generally determined by the restrictions imposed for production of the cooling roll to be described later. The Rz/Ra is especially preferred to be 4 through 6. Further, the glossiness (75 deg.) of the supporting member is normally 20% or less. In many cases, it is 3 through 15% in particular.

Further, from the viewpoint of ensuring a smooth surface, it is preferred that the waviness of filtered wave on the side of the ink absorbing layer according to JIS-B-0610 (low-area cutoff value: 8 mm; wide-area cutoff value: 0.8 mm; and reference length: 80 mm) should be 1 through 5 μm.

Such projections and depressions are provided on a paper supporting member coated with olefin resin preferably in the following manner: After the polyolefin melted on the basic paper has been subjected to extrusion coating, the resin is pressed against a metallic embossing roll having a desired shape to provide a texture of fine projections and depressions.

When the form of the projections and depressions on the surface of the supporting member is to be changed, the dimension or shape of the projections and depressions of the aforementioned cooling roll is normally changed. This method is commonly used when manufacturing the silver halide color print photographic paper. The known method can be used if the surface characteristics are such that the aforementioned characteristic requirements of the present invention are met.

The relationship of the projections and depressions between the supporting member surface and ink absorbing layer depends on the characteristics of the ink absorbing layer. However, in the case of a porous ink absorbing layer where the ink absorbing layer has a high ink absorbing speed and a void for getting a higher quality print, the dry film is thicker; therefore, a difference of height of the supporting member surface has a greater change of decreasing.

As a result, the recording medium of the present invention produced using such a supporting member is such that the 75-deg. mirror surface glossiness, specified in the JIS-Z-8741, of the surface of the ink absorbing layer side is kept approximately in the range from 5 through 15%.

The glossiness on ht surface of the ink absorbing layer is affected by the aforementioned projection/depression configuration of the supporting member, the fine structure of the ink absorbing layer per se, and the matte agent used on a supplementary basis.

If an excessive amount of matting agent is used, a less sharp image tends to be formed or uneven glossiness (glare) tends to become conspicuous due to a slight difference in glossiness on the image surface subsequent to inkjet recording. To minimize the adverse effect on the image, it is preferred to use the matting agent having a mean particle size of 0.5 through 30 μm, or preferably the one having a mean particle size of about 1 through 20 μm.

The following describes the porous ink absorbing layer arranged on the supporting member:

The porous ink absorbing layer can be arranged only on one side of the supporting member or on both sides. In this case, the ink absorbing layers arranged on both sides can be the same or different from each other.

On the porous ink absorbing layer, a void structure is formed of a hydrophilic binder and inorganic fine particles. Such inorganic fine particles include light calcium carbonate, heavy calcium carbonate, magnesium carbonate, karyon, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, synthetic amorphous silica, colloidal silica, alumina, colloidal alumina, pseudoboehmite, aluminum hydroxide, lithopone, zeolite, magnesium hydroxide and such white inorganic fine pigments.

Such inorganic fine particles can be used directly in the form of primary particles, or in the form of secondary coagulated particles or tertiary coagulated particles.

In the present invention, use of silica or pseudoboehmite is preferred since particularly fine voids can be formed. Particularly, the silica, colloidal silica and pseudoboehmite, having a mean particle size 100 nm or less, synthesized according to the vapor phase synthetic method is preferred. Further, the silica, having a mean particle size 100 nm or less, synthesized according to the vapor phase synthetic method is preferred since it is economical and can be formed with a high void ratio.

To obtain the mean particle size of the inorganic fine particles, the sectional area and surface of the particles or ink absorbing layer is observed by a microscope, and the sizes of random 100 particles are found. The mean particle size of the inorganic fine particles is obtained as the simple mean value (number size average) thereof. The individual particle size here is expressed in the diameter when a circle equivalent to the projected area is assumed.

The hydrophilic binder used in the porous ink absorbing layer includes polyvinyl alcohol, gelatine, polyethylene oxide, polyvinyl pyrrolidone, agar, casein, starch, polyacrylic acid, polyacrylic amide, and such known binders. The preferred hydrophilic binder is polyvinyl alcohol.

The polyvinyl alcohol preferably used in the present invention also includes the modified polyvinyl alcohol such as polyvinyl alcohol with the terminal subjected to cation modification and anion modified polyvinyl alcohol containing anion group, in addition to the normal polyvinyl alcohol obtained by hydrolysis of polyacetate vinyl.

The polyvinyl alcohol gained by hydrolysis of vinyl acetate is preferred to have a mean degree of polymerization of 500 or more. Particularly, the polyvinyl alcohol having a mean degree of polymerization of 1000 through 5000 is preferred. Its degree of saponification is preferred to be 70 through 100%, and is particularly preferred to be 80 through 99.5%.

Further, the polyvinyl alcohol derivative, that can be crosslinked by the ionizing radiation, disclosed in the Japanese Patent Tokkaihei 1-286886 and Tokugan 2002-239073, as one type of polyvinyl alcohol derivative, is also a preferable hydrophilic binder that can be used in the present invention. After the coating solution containing such polyvinyl alcohol is applied to the supporting member, the ionizing radiation such as ultraviolet ray is applied thereto. Then the coating solution is formed into a gel. Even if a strong wind is blown to the gel, the coating film is scarcely affected. Thus, this is effectively used for highly productive coating of recording medium.

Further, when the aforementioned ink absorbing layer contains polyvinyl alcohol as a hydrophilic binder, the crosslinking agent such as boric acid or its salt and epoxy based compound can be used to improve the film forming capability of the coating and enhance its strength. The boric acid or its salt refers to the oxyacid having a boron atom as a central atom and the salt thereof. To put it more specifically, it includes orthoboric acid, metaboric acid, hypoboric acid, tetraboric acid, pentaboric acid and salts thereof.

The amount of boric acid and its salt to be used varies widely according to the amount of the inorganic fine particles and hydrophilic polymer in coating solution. It is 1 through 60 percent by mass relative to hydrophilic polymer preferably 5 through 40 percent by mass.

Further, the epoxy based curing agent may be a compound containing at least two glycine groups and a polymer.

The crosslinking agent of the aforementioned polyvinyl alcohol can be used even when the polyvinyl alcohol that can be crosslinked by the aforementioned ionizing ray is employed. A stronger film can be provided.

The aforementioned porous ink absorbing layer may be a single layer or a multiple layer comprising more than two layers. The ink absorbing layer is required to have a thickness sufficient to absorb ink. Since the maximum ink emission for general use is 20 through 25 ml/m², the dry film thickness of the ink absorbing layer is preferably 30 through 50 μm.

The ink absorbing layer of the inkjet recording medium in the present invention may contain various additives other than the aforementioned ones.

A cationic mordant is preferred to improve the resistant to water or moisture subsequent to printing.

The cationic mordant that is used is a polymer mordant containing the primary, secondary and tertiary amino groups and quaternary ammonium base. Use of a polymer mordant containing the quaternary ammonium base is preferred because it is comparatively free from discoloration after a long-term storage and deterioration of resistance to light, and is provided with a sufficiently high mordanting performance of the dye. The preferred polymer mordant is obtained as a homopolymer of the monomer containing the aforementioned quaternary ammonium base, a copolymer with other monomers or a condensation polymer.

In addition to the above the ultraviolet ray absorbing agent disclosed in the Official Gazette of Japanese Patent Tokkaisho 57-74193, the Official Gazette of Japanese Patent Tokkaisho 57-87988 and the Official Gazette of Japanese Patent Tokkaisho 62-261476; the anti-discoloring agent, and anion, cation and non-ion surface active agents of various types disclosed in the Official Gazette of Japanese Patent Tokkaisho 57-74192, the Official Gazette of Japanese Patent Tokkaisho 57-87989, the Official Gazette of Japanese Patent Tokkaisho 60-72785, the Official Gazette of Japanese Patent Tokkaisho 61-146591, the Official Gazette of Japanese Patent Tokkaihei 1-95091 and the Official Gazette of Japanese Patent Tokkaihei 3-13376; the fluorescent whitening agent, defoaming agent, lubricant such as diethylene glycol, preservative agent, thickener, antistatic agent and matting agent disclosed in the Official Gazette of Japanese Patent Tokkaisho 59-42993, Official Gazette of Japanese Patent Tokkaisho 59-52689, Official Gazette of Japanese Patent Tokkaisho 62-280069, Official Gazette of Japanese Patent Tokkaisho 61-242871 and Official Gazette of Japanese Patent Tokkaihei 4-219266; and

various other commonly known additives.

In the recording medium of the present invention, the porous ink absorbing layer of the present invention preferably contains at least one compound selected from:

urea,

an urea derivative,

a compound containing at least two hydroxyl groups in a molecule,

a compound containing at least two aliphatic ether groups in a molecule,

a latex emulsion with Tg not exceeding 10° C., and

an oil dispersion of a hydrophobic compound having a melting point not exceeding 40° C.

If it is preferably contained, the abrasion resistance of the ink absorbing layer can be further improved and it is possible to minimize cracks that may occur during the process of coating and drying in the formation of a porous ink absorbing layer.

If the aforementioned compounds are water-soluble, they can be supplied to the ink absorbing layer by overcoating the compounds, for example, according to the method disclosed in the Japanese Patent Tokugan 2002-258715, after formation of the ink absorbing layer.

The following shows an example of the urea derivative of the present invention, without the present invention being restricted thereto.
U-1: NH₂CONHCH₃
U-2: CH₃NHCONHCH₃
U-3: C₂H₅NHCONH₂
U-4: C₂H₅NHCONHC₂H₅
U-5: (n) C₄H₉NHCONH₂
U-6: (n) C₄H₉NHCONHC₄H₉ (n)

The following shows an example of the compound whose molecular weight where at least two aliphatic hydroxyl groups are contained in the molecule of the present invention is 2000 or less, without the present invention being restricted thereto.
PO-1: HOCH₂CH₂OH
PO-2: HOCH₂CH₂OCH₂CH₂OH
PO-3: HOC₂H₄OC₂H₄OC₂H₄OH
PO-4: HOC₃H₆OH
PO-5: HOC₂H₄SC₂H₄SC₂H₄OH 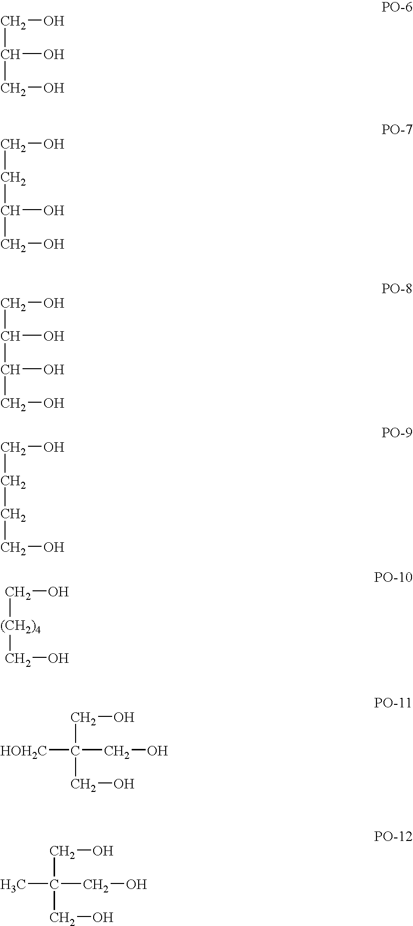
PO-13: Polyethylene glycol (average molecular weight=300)
PO-14: Polyethylene glycol (average molecular weight=1700)
PO-15: Polypropylene glycol (average molecular weight=300)

Further, the compound containing at least two aliphatic ether groups in the molecule of the present invention is preferably the water soluble compound. An example of this compound is given below, without the present invention being restricted thereto:
ET-1: HOC₂H₄OC₂H₄OC₂H₄OC₄H₉
ET-2: HOC₂H₄OC₂H₄OC₄H₉
ET-3: CH₃COOC₂H₄OC₂H₄OC₄H₉ (n)
ET-4: (n) C₄H₉OC₂H₄OC₂H₄OC₄H₉ (n)
ET-5: (n) C₄H₉OC₂H₄OC₄H₉ (n)
ET-6: C₂H₅OC₂H₄OC₂H₄OC₂H₄OC₂H₅
ET-7: CH₃OC₂H₄OC₂H₄OC₂H₄OCH₃
ET-8: (n) C₄H₉OC₂H₄OC₂H₄OC₂H₄OC₄H₉ (n)
ET-9: (n) HOC₂H₄OC₂H₄OC₂H₄OC₂H₅
ET-10: (n) CH₃COOC₂H₄OC₂H₄OC₂H₅

The latex emulsion Tg of the present invention not exceeding 10° C. includes the homopolymer or copolymer of polymerizable monomer having an unsaturated linkage. Such a polymerizable monomer includes ethylene, propylene, butadiene, vinyl acetate and its partial hydrolysate, vinyl ether, acrylic acid and its ester, methacrylic acid and its ester, acrylamide and its derivative, methacrylamide and its derivative, styrene, divinyl benzene, polyvinyl chloride, vinylidene chloride, maleic acid and vinyl pyrrolidone.

From these commonly known polymerizable monomers, selection is made in such a way that Tg will be 10° C. or less, and emulsion polymerization is performed according to a predetermined method, whereby latex emulsion is obtained. In this case, the latex emulsion having been subjected to emulsion polymerization in the presence of a hydrophilic binder such as polyvinyl alcohol is capable of working as an inorganic fine particle binder. Further, it does not require an excessive amount of surface active agent.

The particle size of the latex emulsion is generally 0.02 through 2 μm, preferably 0.05 through 1 μm.

Further, wide-ranging hydrophobic compounds can be used as the hydrophobic compound having a melting point of 40° C. or less. The commonly known hydrophobic organic solvents having a high boiling point (e.g. esters such as phthalic acid ester and phosphoric acid ester, aliphatic esters, paraffins, all sorts of hydrophobic polymer as a 40° C. solution, etc.) can be used preferably.

These hydrophobic compounds are preferably contained in the ink absorbing layer in the form emulsified and dispersed in the hydrophilic binder (gelatine and polyvinyl alcohol preferred) according to the oil-in water type dispersion method. They can also be supplied by being dissolved in the volatile organic solvent (e.g. acetone, ethyl acetate, methyl ethyl ketone, ethanol, n-propanol, n-butanol, toluene) and being coated on the ink absorbing layer, after an air gap has been formed.

The amount of the substance to be added into the ink absorbing layer is preferably 0.5 through 10 percent by mass with respect to the inorganic fine particle, where the aforementioned substance includes urea, an urea derivative, a compound containing at least two hydroxyl groups in a molecule; a compound containing at least two aliphatic ether group in a molecule; a latex emulsion with Tg not exceeding 10° C.; and an oil dispersion of a hydrophobic compound having a melting point not exceeding 40° C. If the amount is below 0.5% by mass, the effect will be reduced. If it exceeds 10 percent by mass, void capacity will be reduced or the bleeding will be adversely affected. The particularly preferred amount is 1 through 8 percent by mass.

When the ink absorbing layer is coated on the supporting member of the present invention, the supporting member is preferably provided with corona discharging or undercoating in order to increase the bonding strength between the supporting member surface and ink absorbing layer.

In addition to gelatine and polyvinyl alcohol, a wide variety of latex emulsion can be used for the undercoated layer. The thickness of the undercoated layer is generally 0.02 through 0.4 μm.

In order to protect against electrostatic charging and curling, and improve resistance against sticking and ink transfer immediately after printing, a wide variety of back layers are preferably provided on the side opposite to the side, of the inkjet recording medium, having the ink absorbing layer.

A hydrophilic binder or hydrophobic binder is commonly used as the back layer, although it may differ according to the thickness of the type of the supporting member and the arrangement and thickness on the front side. The back layer is normally 0.1 through 10 μm thick.

To protect against sticking to other inkjet recording medium, to improve the ease in writing and enhance conveyance in the inkjet recording apparatus, the back layer is preferably provided with a rough surface. The organic or inorganic fine particles having a particle size of 2 through 20 μm are preferably used for this purpose. The back layer may be provided in advance or after the porous ink absorbing layer of the present invention has been provided by coating.

The friction coefficient on the surfaces of the back layer and ink absorbing layer is crucial for the performance in conveyance. For continuous paper feed during the process of printing, the friction coefficient on the obverse and reverse sides is preferably 0.9 or less, more preferably 0.8. or less. If it exceeds 0.9, conveyance of duplicate sheets tends to occur. The lower limit of the friction coefficient is 0.15 or more in normal cases, although there is no special restriction thereon.

Further, when the surface roughness of the back layer is considered from the viewpoint of abrasion resistance at the time of manufacturing and handling, the surface roughness Ra is preferably 0.5 through 5.0 μm, with Rz of 1 through 20 μm, Rmax=2 through 40 μm and glossiness of 5 through 30%.

The ink absorbing layer can be coated according to the roll coating method, rod bar coating method, air knife coating method, spray coating method, curtain coating method, or hopper-based extrusion coating method disclosed in the U.S. Pat. No. 2,681,294 and so on. The curtain coating method or extrusion coating method is preferably used since the porous ink absorbing layer must be coated under conditions of high wet film thickness.

The supporting member temperature preferably rises to 30 through 50° C. before the ink absorbing layer is coated, because the coating performance is improved. The viscosity of the coating solution for the ink absorbing layer is commonly 40 through 1000 mPa.s, more preferably 50 through 500 mPa.s. The viscosity can be measured by a B-type viscometer.

Coating is provided preferably by the simultaneous multiple layer method wherein all the ink absorbing layers are coated simultaneously. The thickness of the film to be coated is generally 3 through 6 times the thickness of a dry film, ranging 3 through 5 times. Normally, the thickness of a wet film is 100 through 250 μm. The coating rate is generally 10 through 1000 m/min.

After coating, the material is formed into a gel by cooling or is thicken extremely; then it is dried. This method ensures that uneven dispersion of solution or uneven coating due to blowing does not occur easily even when strong air is blown, and is suited for high-speed coating. In this case, after the coating solution for forming the ink absorbing layer has been applied, it is cooled until the temperature of the film surface is 20° C. or less. Then it is exposed to the air of higher temperature and uneven coating due to blowing is minimized, whereby outstanding film coating quality is obtained.

Since polyolefin coating paper is used as a supporting member, the maximum temperature of the air used for drying is approximately 90° C. or less, preferably 80° C. or less, from the viewpoint of the heat resistance of polyolefin resin. If the temperature exceeds 80° C., the polyolefin resin will soften to cause a conveyance problem or to cause uneven gloss on the surface of the recording layer. The preferred drying temperature is 0 through 60° C.

The ink absorbing layer surface of the present invention preferably-has the following advantages:

Bekk smoothness: 50 through 500 seconds. (ink absorbing layer side), 100 through 1000 seconds. (back layer side)

White background: L*=88 through 96, a*=−3 through +3, b*=−8 through +3

Opacity: 88 through 98%

The inkjet recording medium of the present invention is preferably used with water based dyestuff ink and water based pigment ink. It is also used with oil based pigment ink.

### EXAMPLE

The following provides a specific description of the present invention with reference to embodiments, without the present invention being restricted thereto. “%” appearing in the embodiment indicates percent by mass in absolute dry condition unless otherwise specified.

Embodiment 1

<<Manufacture of Supporting Member>>

Obverse size pressing is provided on the obverse and reverse sides. The low-density polyethylene having a density of 0.92 was applied on the reverse side of the photo-grade base paper having a moisture content of 7.5 percent by mass with a basis weight of 180 g/m², to a thickness of 35 μm according to the melt-extrusion coating method. Then the low-density polyethylene, containing 7 percent by mass of anatase type titanium oxide, having a density of 0.92 was applied on the obverse side to a thickness of 40 μm according to the melt-extrusion coating method. Thus, supporting members A through F with both sides covered with polyethylene were manufactured. The reverse side was pressed against a cleaning roll having a matte surface immediately after coating by melt-extrusion, and the matte surface was embossed. On the obverse side, various forms of embossing were provided on the polyethylene surface in the process of being cooled, immediately after coating by melt extrusion, using a cleaning roll with various regular projections/depressions provided on the surface (8 projections/depressions with having a difference of height of about 16 μm arranged at intervals of 3 mm). The difference in the forms of embossing was given by changing the profile. Table 1 shows the surface characteristics on the side coated with the ink absorbing layer for the supporting members A through F.

The center line average roughness (Ra) and ten-point mean roughness (Rz) described in Table 1 was measured by the Model RSTPLUS non-contact 3D microscopic surface profile measuring system by Wyko according to the aforementioned method. To get the glossiness on the obverse side, the varied angle glossmeter (VGS-1001DP) by Nippon Denshoku Industries Co., Ltd. was used to measure the 75-deg. gloss.

Then corona discharging was applied to the obverse side, and the gelatine undercoating layer containing the curing agent was coated to a thickness of 0.03 g/m². Corona discharging was applied on the reverse side, and the back layer containing the silica based matte agent and latex was coated to a thickness of 0.2 g/m².

The center line average roughness (Ra) on the obverse side of the supporting member obtained in the aforementioned manner was about 1.4 μm in all cases and the ten-point mean roughness (Rz) was about 17.9 μm, with the Bekk smoothness lying between 200 and 300 seconds.

<<Preparing the Ink Absorbing Layer>>

The ink absorbing layer coating solution for the observed was prepared according to the following procedure.

(Preparing the Silica Dispersant B)

The solution A including the following compositions was prepared:

| | | |
|---|---|---|
| Water | 1420 | L |
| Boric acid | 5.4 | kg |
| Borax | 4.8 | kg |
| Ethanol | 44 | L |
| 25% cationic polymer (P-1) aqueous solution | 340 | L |
| Fluorescent whitening agent (W1*) | 2.0 | L |
| Defoaming agent (Deforming agent SN381 by Sannobuko | 200 | g |
| Co., Ltd.) | | |

Pure water was used to ensure that the total volume would be 2000 liters.
W1*: UNITEX NFW LIQUID by Chiba Speciality Chemical Company.
Cationic polymer (P-1)

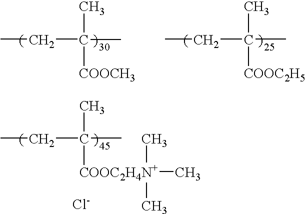

Then 400 kg of silica according to chemical vapor deposition method (mean primary particle size: 12 nm) was prepared as inorganic fine particles. The silica according to chemical vapor deposition method and solution A prepared in the aforementioned step were continuously fed and mixed at the same ratio. According to the dispersion method described in the fifth embodiment of the Official Gazette of Japanese Patent Tokkai 2002-47454, they were sufficiently kneaded and dispersed on a preliminary basis. Then they were continuously dispersed by a sand mill dispersing machine. They were dispersed by a high pressure homogenizer to get clear silica dispersed solution B. In this case, the aforementioned steps were taken by adjusting the flow rate so that the amount of the solution A for 1 kg of silica according to chemical vapor deposition method would be 4.7 liters. Dispersion was carried out continuously by cooling in such a way that the temperature of the dispersed solution during the process of sand mill dispersion and high pressure dispersion would not exceed 50° C.

The concentration of the silica in the silica dispersed solution B obtained in the aforementioned manner was adjusted by pure water to ensure that the silica would be 18 percent by mass for one liter of the silica dispersed solution in the final phase. The silica dispersed solution B obtained in this manner had a pH value of 4.5.

(Preparing the Silica Dispersed Solution D)

The silica dispersed solution C containing the following compositions were prepared:

| | | |
|---|---|---|
| Water | 1420 | L |
| Boric acid | 5.4 | kg |
| Borax | 4.8 | kg |
| Ethanol | 44 | L |
| 25% cationic polymer (P-2) aqueous solution | 340 | L |
| Fluorescent whitening agent (W1*) | 2.0 | L |
| Defoaming agent (Deforming agent SN381 by | 200 | g |
| Sannobuko Co., Ltd.) | | |
| Pure water was used to ensure that the total | | |
| volume would be 2000 liters. | | |

Silica dispersed solution D was prepared using the silica according to chemical vapor deposition method and solution C by the same method as the dispersion method for silica dispersed solution B. 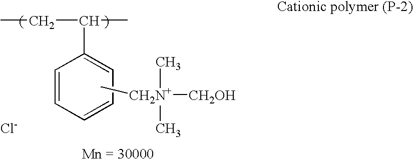
(Preparing the Coating Solution)

The ink absorbing layer coating solutions E and F of the following composition were prepared using the silica dispersed solutions B and D prepared in the aforementioned steps. The composition of each ink absorbing layer coating solution indicates that for each liter of the coating solution.

(Ink absorbing layer coating solution E)

| | |
|---|---|
| Silica dispersed solution B | 550 ml |
| Pure water | 210 ml |
| Polyvinyl alcohol (saponification: 88%; mean degree of | 225 ml |
| polymerization: about 4000; aqueous solution: 8%) | |

Pure water was used to ensure that the total volume would be
1000 ml.

(Ink absorbing layer coating solution F)

| | |
|---|---|
| Silica dispersed solution D | 550 ml |
| Pure water | 200 ml |
| Polyvinyl alcohol (saponification: 88%; mean degree of | 220 ml |
| polymerization: about 4000; aqueous solution: 8%) | |
| Surface active agent (SF-1 5% aqueous solution) | 5.5 ml |

Pure water was used to ensure that the total volume would be
1000 ml.
SF-1

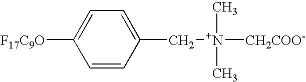

The ink absorbing layer coating solutions E and F prepared in the aforementioned steps were filtrated by a filter (50% capturing efficiency: 20 μm). The viscosity of each ink absorbing layer coating solution was 40 through 50 mPa.s at 40° C. and about 50,000 mPa.s at 15° C.

<<Preparing the Recording Medium>>

Two layers were simultaneously coated on the obverse side of the supporting members A through F produced in the aforementioned manner and provided with undercoating, to the following wet film thickness, using the ink absorbing layer coating solutions E and F prepared in the aforementioned steps, whereby recording media 1 through 6 were created.

1st layer (lower layer: ink absorbing layer coating solution E): wet film thickness=100 μm

2nd layer (lower layer: ink absorbing layer coating solution F): wet film thickness=90 μm

A ink absorbing layer coating solution having a temperature of 45° C. were coated on the supporting members A through F, continuously traveling at the rate of 120 m/min., having a width of 1.5 m, using a slide hopper coating machine.

After coating, the continuously traveling supporting members having been coated were cooled at 4° C. for ten seconds and were fed through the following drying zone, whereby these supporting members were dried.
1st zone: 30° C., 10% RH or less for 30 sec.
2nd zone: 55° C., 10% RH or less for 60 sec.
3rd zone: 60° C., 10% RH or less for 60 sec.
4th zone: 65° C., 10% RH or less for 60 sec.
5th zone: 55° C., 10% RH or less for 30 sec.

The fifth zone was the terminal point for drying. In the process of drying, air conforming to the aforementioned conditions was blown directly against the surface to be coated according to the air loop method. After the process of drying, a roll of recording medium was stored at 35° C. for one week. The dry film thickness subsequent to drying was as follows:

1st layer: dry film thickness: 19 μm

2nd layer: dry film thickness: 16.5 μm

Then each recording medium was trimmed to A4-sized sheet, and 50 sheets as one unit were sealed into a package including a polycarbonate film.

<<Image Formation and Evaluation>>

A photographic image was printed on each recording medium produced in the aforementioned steps, using the PM-G800 inkjet printer and genuine ink by Seiko Epson Corp., and the following evaluation was made on the image obtained therefrom:

[Evaluation of Surface Texture]

The image printed surface was visually checked to see if the silky texture was formed or not.

[Evaluation of Crack Resistance]

The image surface was checked visually and by a magnifier to see if any crack occurred thereon or not. Crack resistance was evaluated according to the following criteria:
A: No crack was found at all in a check using a magnifier.
B: Not more than ten cracks having a diameter of 0.5 mm or less were found for each A4-sized sheet.
C: Ten or more cracks having a diameter of 0.5 mm or less were found for each A4-sized sheet. Alternatively, two or less cracks having a diameter of over 0.5 mm were found for each A4-sized sheet, and they are permissible for practical purposes.
D: Three or more cracks having a diameter of 0.5 mm or more were found for each A4-sized sheet.
   [Evaluation of Vibration Resistance]

A vibration tester was used to apply vibration to each of the samples sealed in packages produced in the aforementioned steps. Then an image was formed according to the aforementioned method. The conditions of the film surface subsequent to printing was visually checked, and the vibration resistance was evaluated according to the following criteria:
A: No trace of abrasion resulting from vibration
B: Traces of slight uneven glossiness were observable, without any impact on print tone.
C: Uneven glossiness of intermediate level was observable, without any impact on print tone.
D: Bronzing or mottle-like marks were produced to give a serious impact to the print.

Table 1 shows the results of the aforementioned evaluation:

TABLE 1

| | | | | | | Evaluation result | | | |
|---|---|---|---|---|---|---|---|---|---|
| | Supporting member | | | | | Surface | | | |
| Record- | | Surface | | | | texture | | Vibra- | |
| ing | | roughness | | | Glossi- | (evaluation | Crack | tion | |
| medium | | Rz | Ra | | ness | of silky | resis- | resis- | |
| No. | No. | (μm) | (μm) | Rz/Ra | 75° | texture) | tance | tance | Remarks |
| 1 | A | 12.5 | 2.9 | 4.31 | 11 | Clear silky | B | B | Inv. |
| | | | | | | texture | | | |
| 2 | B | 16.0 | 2.9 | 5.52 | 11 | Clear silky | B | B | Inv. |
| | | | | | | texture | | | |
| 3 | C | 16.9 | 2.7 | 6.26 | 10 | Clear silky | B | C | Inv. |
| | | | | | | texture | | | |
| 4 | D | 22.8 | 3.6 | 6.33 | 10 | Clear silky | C | C | Inv. |
| | | | | | | texture | | | |
| 5 | E | 21.1 | 2.8 | 7.54 | 12 | Clear silky | C | D | Comp. |
| | | | | | | texture | | | |
| 6 | F | 12.5 | 1.6 | 7.81 | 18 | Obscure | B | A | Comp. |
| | | | | | | silky | | | |
| | | | | | | texture | | | |

Inv.: Present invention
Comp.: Comparative example

As is clear from the results of evaluation given in Table 1, recording media 1 through 5 were provided with a large-patterned silky texture. However, the recording medium 6 was provided with only obscure silky texture due to one fine profile laid on top of another.

Further, the recording media 1 through 4 of the present invention wherein the Rz/Ra is from 4 through 7 were provided with outstanding vibration resistance. Particularly the recording media 1 through 2 having a Rz/Ra value of 4 through 6 exhibited satisfactory results. The recording medium 5 having a Rz/Ra value of over 7 exhibited poor vibration resistance and inferior abrasion resistance.

Embodiment 2

Recording media 11 through 16 were produced in the same procedure, except that the ink absorbing layer coating solutions E and F were replaced by the following ink absorbing layer coating solutions G, H, I, J, K, L, M, N, O, P, Q and R, in the production of the recording medium 2 (supporting member B) of the first embodiment:

| | | |
|---|---|---|
| [Production of recording medium 11] | | |
| (Ink absorbing layer coating solution G) | | |
| Silica dispersed solution B | 550 | ml |
| Pure water | 210 | ml |
| Polyvinyl alcohol (saponification: 88%; mean degree of | 225 | ml |
| polymerization: about 4000; aqueous solution: 8%) | | |
| Urea (20% aqueous solution) | 10 | ml |
| Pure water was used to ensure that the total volume would be | | |
| 1000 ml. | | |
| (Ink absorbing layer coating solution H) | | |
| Silica dispersed solution D | 550 | ml |
| Pure water | 200 | ml |
| Polyvinyl alcohol (saponification: 88%; mean degree of | 220 | ml |
| polymerization: about 4000; aqueous solution: 8%) | | |
| Surface active agent (SF-1 5% aqueous solution) | 5.5 | ml |
| Urea (20% aqueous solution) | 10 | ml |
| Pure water was used to ensure that the total volume would be | | |
| 1000 ml. | | |
| [Production of recording medium 12] | | |
| (Ink absorbing layer, coating solution I) | | |
| Silica dispersed solution B | 550 | ml |
| Pure water | 210 | ml |
| Polyvinyl alcohol (saponification: 88%; mean degree of | 225 | ml |
| polymerization: about 4000; aqueous solution: 8%) | | |
| 20% aqueous solution of Illustrated compound U-2 | 10 | ml |
| Pure water was used to ensure that the total volume would be | | |
| 1000 ml. | | |
| (Ink absorbing layer coating solution J) | | |
| Silica dispersed solution D | 550 | ml |
| Pure water | 200 | ml |
| Polyvinyl alcohol (saponification: 88%; mean degree of | 220 | ml |
| polymerization: about 4000; aqueous solution: 8%) | | |
| 20% aqueous solution of Illustrated compound U-2 | 10 | ml |
| Surface active agent (SF-1 5% aqueous solution) | 5.5 | ml |
| Pure water was used to ensure that the total volume would be | | |
| 1000 ml. | | |
| [Production of recording medium 13] | | |
| (Ink absorbing layer coating solution K) | | |
| Silica dispersed solution B | 550 | ml |
| Pure water | 200 | ml |
| Polyvinyl alcohol (saponification: 88%; mean degree of | 225 | ml |
| polymerization: about 4000; aqueous solution: 8%) | | |
| 10% aqueous solution of Illustrated compound PO-3 | 20 | ml |
| Pure water was used to ensure that the total volume would be | | |
| 1000 ml. | | |
| (Ink absorbing layer coating solution L) | | |
| Silica dispersed solution D | 550 | ml |
| Pure water | 200 | ml |
| Polyvinyl alcohol (saponification: 88%; mean degree of | 220 | ml |
| polymerization: about 4000; aqueous solution: 8%) | | |
| Surface active agent (SF-1 5% aqueous solution) | 5.5 | ml |
| 10% aqueous solution of Illustrated compound PO-3 | 20 | ml |
| Pure water was used to ensure that the total volume would be | | |
| 1000 ml. | | |
| [Production of recording medium 14] | | |
| (Ink absorbing layer coating solution M) | | |
| Silica dispersed solution B | 550 | ml |
| Pure water | 210 | ml |
| Polyvinyl alcohol (saponification: 88%; mean degree of | 225 | ml |
| polymerization: about 4000; aqueous solution: 8%) | | |
| 10% aqueous solution of Illustrated compound PE-5 | 10 | ml |
| Pure water was used to ensure that the total volume would be | | |
| 1000 ml. | | |
| (Ink absorbing layer coating solution N) | | |
| Silica dispersed solution D | 550 | ml |
| Pure water | 200 | ml |
| Polyvinyl alcohol (saponification: 88%; mean degree of | 220 | ml |
| polymerization: about 4000; aqueous solution: 8%) | | |
| Surface active agent (SF-1 5% aqueous solution) | 5.5 | ml |
| 10% aqueous solution of Illustrated compound PE-5 | 20 | ml |
| Pure water was used to ensure that the total volume would be | | |
| 1000 ml. | | |
| [Production of recording medium 15] | | |
| (Ink absorbing layer coating solution O) | | |
| Silica dispersed solution B | 550 | ml |
| Pure water | 170 | ml |
| Polyvinyl alcohol (saponification: 88%; mean degree of | 225 | ml |
| polymerization: about 4000; aqueous solution: 8%) | | |
| Emulsion latex A (*1) | 40 | ml |
| Pure water was used to ensure that the total volume would be | | |
| 1000 ml. | | |
| (Ink absorbing layer coating solution P) | | |
| Silica dispersed solution D | 550 | ml |
| Pure water | 200 | ml |
| Polyvinyl alcohol (saponification: 88%; mean degree of | 220 | ml |
| polymerization: about 4000; aqueous solution: 8%) | | |
| Surface active agent (SF-1 5% aqueous solution) | 5.5 | ml |
| Pure water was used to ensure that the total volume would be | | |
| 1000 ml. | | |
| [Production of recording medium 16] | | |
| (Ink absorbing layer coating solution Q) | | |
| Silica dispersed solution B | 550 | ml |
| Pure water | 170 | ml |
| Polyvinyl alcohol (saponification: 88%; mean degree of | 225 | ml |
| polymerization: about 4000; aqueous solution: 8%) | | |
| Liquid paraffin (melting point: below 10° C.) | 40 | ml |
| Pure water was used to ensure that the total volume would be | | |
| 1000 ml. | | |
| (Ink absorbing layer coating solution R) | | |
| Silica dispersed solution D | 550 | ml |
| Pure water | 200 | ml |
| Polyvinyl alcohol (saponification: 88%; mean degree of | 220 | ml |
| polymerization: about 4000; aqueous solution: 8%) | | |
| Surface active agent (SF-1 5% aqueous solution) | 5.5 | ml |
| Pure water was used to ensure that the total volume would be | | |
| 1000 ml. | | |

(*1) Emulsion latex A: acryl based emulsion (Acryl based latex subjected to emulsification and polymerization in the presence of polyvinyl alcohol wherein Tg = −15° C., mean particle size is about 0.12 μm, degree of saponification is 88%, mean degree of polymerization is about 3500. Content of solid acryl based resin = 15%)

<<Image Formation and Evaluation>>

Using the recording medium produced in the aforementioned manner, a photographic image is printed out according to the same method as that described in the first embodiment, and the image obtained in this manner is evaluated for the surface texture, crack resistance and vibration resistance. Table 2 shows the results of this evaluation.

TABLE 2

| | | | Surface | | | |
|---|---|---|---|---|---|---|
| Record- | Suport- | Ink | texture | | Vibra- | |
| ing | ing | absorbing | (evaluation | Crack | tion | |
| medium | member | layer | of silky | resis- | resis- | |
| No. | No. | additive | texture) | tance | tance | Remarks |
| 11 | B | Urea | Clear silky | A | A | Present |
| | | | texture | | | invention |
| 12 | B | Illustrated | Clear silky | A | A | Present |
| | | compound | texture | | | invention |
| | | U-2 | | | | |
| 13 | B | Illustrated | Clear silky | A | A | Present |
| | | compound | texture | | | invention |
| | | PO-3 | | | | |
| 14 | B | Illustrated | Clear silky | A | A | Present |
| | | compound | texture | | | invention |
| | | PE-5 | | | | |
| 15 | B | Emulsion | Clear silky | A | A | Present |
| | | latex | texture | | | invention |
| 16 | B | Liquid | Clear silky | A | A | Present |
| | | paraffin | texture | | | invention |

From the results shown in Table 2, it is clear that a porous ink absorbing layer containing urea, an urea derivative, a compound containing at least two hydroxyl groups in a molecule, a compound containing at least two aliphatic ether groups in a molecule, and a latex emulsion with Tg not exceeding 10° C. is characterized by an outstanding silky texture surface and improved resistance to crack and vibration.

1. An inkjet recording medium comprising:
a support on which polyolefin resin is coated; and
a porous ink absorbing layer containing a hydrophilic binder and inorganic fine particles, which is provided on the support,
wherein a surface facing to the ink absorbing layer of the support is a fine-grained surface having about 5 through 10 rugged configurations arranged regularly at intervals of 3 mm; and
wherein the surface has the center-line average roughness is not less than 2.5 μm when a reference length is 2.5 mm and a cutoff value is 0.8 mm, and the ratio of the ten-point mean roughness of the surface to the center-line average roughness thereof is 4 to 7.

2. The inkjet recording medium of claim 1, wherein the center-line average roughness is defined in JIS B 0601 as Ra, and the ten-point mean roughness is defined in the JIS B 0601 as Rz.

3. The inkjet recording medium of claim 1, wherein the dry film thickness of the porous ink absorbing layer is 30 to 50 μm.

4. The inkjet recording medium of claim 1, wherein the porous ink absorbing layer contains at least one substance selected from:
urea,
an urea derivative,
a compound containing at least two hydroxyl groups in a molecule,
a compound containing at least two aliphatic ether groups in a molecule,
a latex emulsion with Tg not exceeding 10° C., and
an oil dispersion of a hydrophobic compound having a melting point not exceeding 40° C.

5. The inkjet recording medium of claim 4, wherein the ratio of the content of the selected substance to the content of the inorganic fine particle is 0.5 to 10 percent by mass.
